(19) United States
(12) Patent Application Publication
(10) Pub. No.: US 2013/0334204 A1
(43) Pub. Date: Dec. 19, 2013

(54) PLANE HEATING FILM FOR INTEGRATED GAS SUPPLY SYSTEM, AND METHOD OF MANUFACTURING SAME

(71) Applicant: TEM-TECH LAB. CO. LTD, Tokyo (JP)

(72) Inventors: Mitsuyoshi AIZAWA, Tokyo (JP); Takaaki HIROOKA, Yamanashi (JP)

(21) Appl. No.: 13/917,056

(22) Filed: Jun. 13, 2013

(30) Foreign Application Priority Data
Jun. 18, 2012 (JP) 2012/136693

(51) Int. Cl. H05B 3/02

(52) U.S. Cl. CPC H05B 3/02
USPC 219/538; 156/62.2

(57) ABSTRACT

A novel heat retainer/heat generator is provided using carbon nanotube (CNT) paper, particularly, a plane heating film suitable for use in an integrated gas supply system for supplying a special gas for semiconductor manufacturing. The plane heating film comprises a piece of electrically conductive paper created by mixing carbon nanotubes with pulp fiber, and processing the mixture into a sheet, electrodes disposed in an end area of the electrically conductive paper for supplying power to the electrically conductive film, and heat-resistive insulating films for laminating both sides of the electrically conductive paper. With the employment of carbon nanotubes, the plane heating film is improved in temperature characteristics, heat generating efficiency, and durability.

### BACKGROUND OF INVENTION

1. Technical Field

The present invention relates to a heat retainer/heat generator and a method of manufacturing same, and more particularly, to a plane heating film for use in an integrated gas supply system for supplying a special gas for semiconductor manufacturing, and a method of manufacturing same.

2. Background Art

FIG. 1 shows a schematic diagram of an integrated gas supply system for supplying a special gas to a semiconductor manufacturing apparatus, where a heat retainer/heat generator provided by the present invention is used in such an integrated gas supply system.

Generally, a special gas for semiconductor manufacturing introduced from a gas intake port 1 is controlled in volume through a gas flow path 2 of an integrated gas supply system (ISG), and delivered to a semiconductor manufacturing apparatus (not shown). The integrated gas supply system comprises a variety of gas flow control devices 5, including a pressure adjuster, a filter, a pressure sensor, a flow meter, and the like, carried on respective integration blocks (carriers) 3 heated by an integration block heat retainer/heat generator 7, through a plane heating film 4. The gas introduced from the gas intake port 1 at a high pressure of approximately 1 MPa and at high temperatures, flows through the variety of gas flow control devices 5 and the gas flow path 2 routed through the integration blocks 3 corresponding thereto, and is delivered from a gas discharge port 6 into the semiconductor manufacturing apparatus as a gas flow.

FIG. 2 is a partially enlarged view showing gas introduction/discharge ports of one of the variety of gas flow control devices 5 of the integrated gas supply system.

The gas flow control device 5 is fixed on the integration block 3 through the plane heating film 4 by a mounting flange 20. A gas flow 28 is introduced from a gas introduction port 21, and discharged from a gas discharge port 22 through the gas flow path 2. Assuming, for example, that the gas flow control device 5 is a pressure measuring device, a pressure sensor 23 is disposed on the gas flow path 2.

The gas flow 28 introduced at high pressure and high temperature gradually reduces its flow rate along bent portions of the gas flow path 2, and collides with the wall of the gas flow path 2. This collision causes a rapid attenuation of flow energy, resulting in crystallization of the gas to produce a deposit 24. This deposit 24 is known to be impediment to the gas flow 28.

To prevent such an impediment, conventionally, the integrated gas flow system is entirely heated by the integration block heat retainer/heat generator 7, and the variety of gas flow control devices 5 are respectively heated by the plane heating film 4, thereby preventing the crystallization of the deposit within the gas flow path 2. In this event, it is important to evenly and efficiently heat or retain the heat of the respective gas introduction/discharge ports of the variety of gas flow control devices 5.

Conventionally, the plane heating film 4 is fixed on the integration block 3 by the mounting flange 20 in order to heat or retain the heat of the respective gas introduction/discharge ports of the variety of gas flow control devices 5.

FIG. 3A shows a top plan view of a conventional plane heating film 4, and FIG. 3B shows a cross-sectional view of same.

The plane heating film 4 comprises an electrically conductive section (heat generating section) and an insulating protection film 33. The electrically conductive section (heat generating section) comprises a metal resistive wire 31 which is made of a metal foil of SUS or the like patterned by etching or the like into fine meanders, and electrodes 32 formed at both ends of the metal resistive wire 31. The insulating protection film 33 is made of a heat-resistive resin film such as polyimide, which is bonded to the electrically conductive section with pressure on both sides thereof, and then patterned into an appropriate shape. The plane heating film 4 also comprises two gas supply ports (with gaskets) 34 for introducing and discharging the gas, and openings 35 at four corners thereof for receiving fixing screws in conformity to the shape of the mounting flange 20.

According to the conventional plane heating film 4, electric power is supplied between the electrodes 32 such that the plane heating film 4 takes advantage of a resulting heat generating effect of the metal resistive wire 31.

However, the conventional plane heating film 4, due to the employment of the metal resistive wire 31 for the electrically conductive section, exhibits a low resistance value per unit length, and accordingly requires a significant amount of electric power in order to generate heat needed for the purpose. Further, due to the employment of the fine metal resistive wire 31, the plane heating film 4 is vulnerable to bending stress, and exhibits a high resistance value in curved portions of the metal resistive wire 31 in particular. Thus, the conventional plane heating film 4 tends to exhibit locally higher temperatures caused by additional heat generated by a current which can concentrate in the curved portions of the metal resistive wire 31, and has the disadvantage of susceptibility to wire break. In the conventional plane heating film 4, the metal resistive wire, if broken, cannot be repaired, and it is extremely difficult to replace the failed plane heating film 4 with a normal one due to the structure of the gas flow control device 5.

### SUMMARY OF INVENTION

To solve the disadvantage of the conventional plane heating film, it is an object of the present invention to provide a novel heat retainer/heat generator plate using carbon-nano-tube (CNT) paper, particularly, a plane heating film suitable for use in an integrated gas supply system for a special gas intended for semiconductor manufacturing. It is another object of the invention to provide a method of manufacturing the plane heating film.

To achieve the above object, the present invention provides a plane heating film using carbon nanotubes, particularly, a plane heating film suitable for use in an integrated gas supply system for a special gas intended for semiconductor manufacturing. The plane heating film comprises a piece of electrically conductive paper produced by mixing carbon nanotubes with pulp fiber, and patterning the mixture into a sheet, electrodes disposed in an end area of the electrically conductive paper for supplying electric power thereto, and a heat-resistive insulating film for laminating both sides of the electrically conductive paper.

The present invention also provides a method of manufacturing a plane heating film, which comprises the steps of patterning a piece of electrically conductive paper in conformity to the shape of the plane heating film, where the electrically conductive film is created by mixing carbon nanotubes with pulp fiber, and processing the mixture into a sheet; adhering a copper-foil electrode cut into the shape of electrode and copper-foil power supply electrodes for supplying power to the copper-foil electrode on the periphery and an end area of the electrically conductive paper; laminating both sides of the patterned electrically conductive paper with an insulating heat-resistive resin film, where the insulating heat-resistive resin film is formed by coating a high-temperature soluble polyamide resin on a polyimide film; and punching the laminated electrically conductive paper into a desired shape.

### BRIEF DESCRIPTION OF DRAWINGS

FIG. 1 shows a schematic diagram of an integrated gas supply system for supplying a special gas to a semiconductor manufacturing apparatus.

FIG. 2 shows a partially enlarged view depicting gas introduction/discharge ports of a gas flow control device in the integrated gas supply system.

FIG. 3A shows a top plan view of a conventional plane heating film.

FIG. 3B shows a cross-sectional view of the conventional plane heating film.

FIG. 4 is a diagram showing the principle of a heat generating effect of a plane heating film comprised of electrically conductive paper which contains carbon nanotubes.

FIG. 5A shows a top plan view of a plane heating film according to the present invention, comprised of electrically conductive paper which contains carbon nanotubes.

FIG. 5B shows a partial cross-sectional view of the plane heating film according to the present invention, comprised of electrically conductive paper which contains carbon nanotubes.

FIG. 6 shows a top plan view of the plane heating film in a first step of a plane heating film manufacturing process according to the present invention.

FIG. 7A shows a top plan view of the plane heating film in a second step of the plane heating film manufacturing process according to the present invention.

FIG. 7B is a partial cross-sectional view of the plane heating film in the second step of the plane heating film manufacturing process according to the present invention.

FIG. 8 shows a top plan view of the plane heating film in a third step of the plane heating film manufacturing process according to the present invention.

FIG. 9A shows a top plan view of the plane heating film in a fourth step of the plane heating film manufacturing process according to the present invention.

FIG. 9B is a partial cross-sectional view of the plane heating film in the fourth step of the plane heating film manufacturing process according to the present invention.

FIG. 10 shows an embodiment of a manufacturing process for mass-manufacturing the plane heating films of the present invention.

FIG. 11 shows an embodiment of the present invention which comprises three plane heating films connected in series.

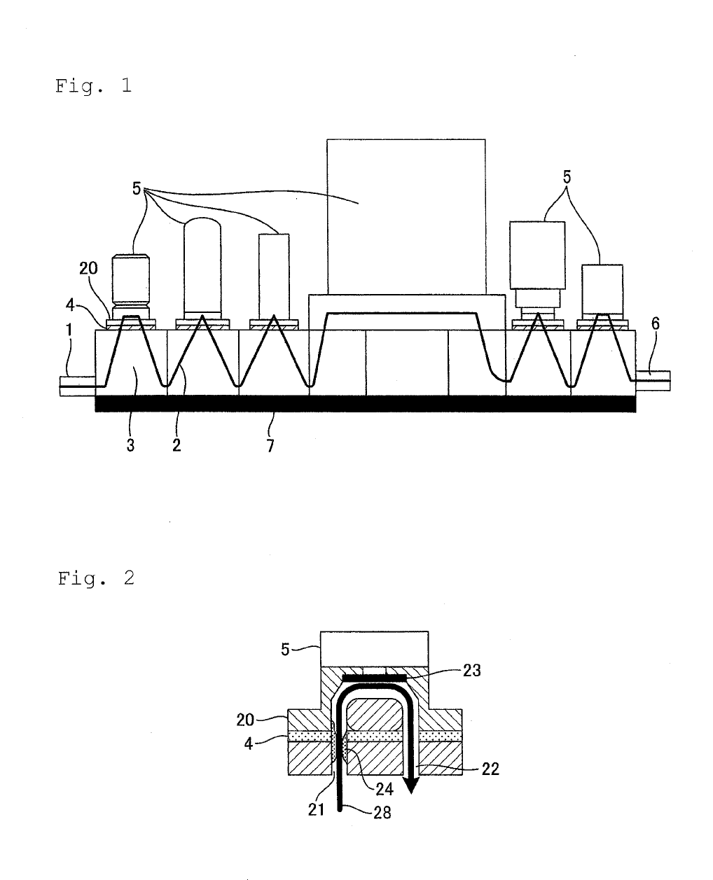

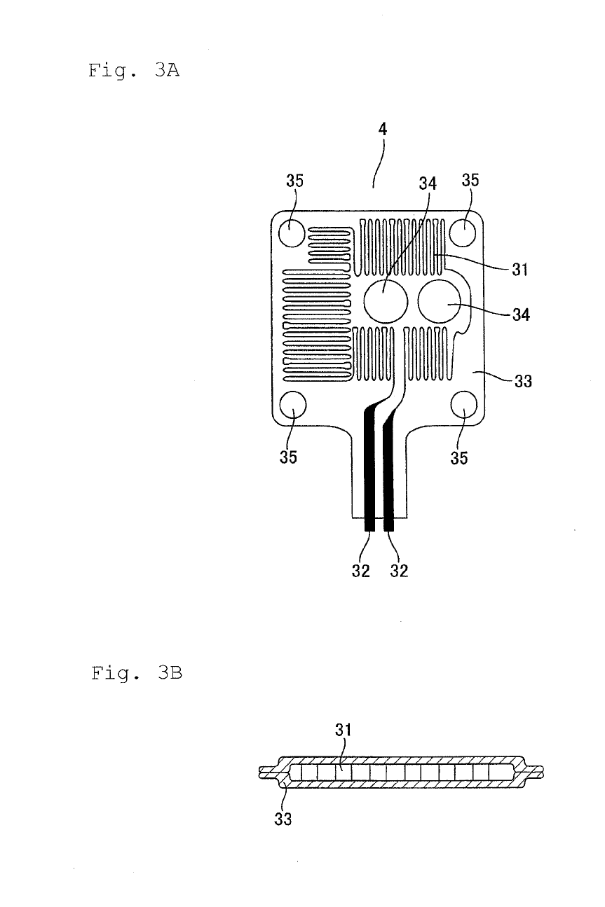

### DESCRIPTION OF EMBODIMENTS

The essence of the present invention lies in a novel heat generating plate which can solve the disadvantage of the conventional plane heating film by employing carbon nanotube (CNT) paper.

A carbon nanotube is generally formed by wrapping up a sheet of graphite, and has a cylindrical shape, known as a carbon material having a diameter of several nanometers and a length of several microns. This material is regarded as an ideal one-dimensional substance because it exhibits the ratio of the length to the diameter equal to or more than 1,000. Further, this material can provide a current density larger than electrically conductive metal materials by one or more orders of magnitude.

When such carbon nanotubes are mixed with pulp fiber, and the resulting mixture is processed into a sheet, electrically conductive paper can be manufactured with good binding with the pulp fiber. When this electrically conductive paper is applied with a current, an ideal flat temperature distribution can be demonstrated as a heat retainer/heat generator.

Such electrically conductive paper exhibits electrical conductivity while having a certain electric resistance. Thus, when electrodes are formed in an end area of the electrically conductive paper and are applied with a voltage, the electrically conductive paper generates heat in accordance with the electric resistance thereof, thus acting as a laminar heat generator. This laminar heat generator provides uniform heat conduction over its entirety by virtue of excellent electric conductivity and thermal conductivity of carbon nanotubes. Moreover, this laminar heat generator serves as a material which excels in mechanical tensile strength and breaking strength with a complement in strength of the pulp fiber with carbon nanotubes entangled in a complicated manner. This electrically conductive paper provides the following benefits when it is applied to a plane heating film.

1. Reduction in distortions of heat generator material due to thermal expansion, and improved temperature characteristics.

2. High heat generating efficiency, and low power consumption.

3. Easy and safe temperature control.

4. Higher durability.

5. Free of wire break, as found in the conventional plane heating film including a metal resistive wire.

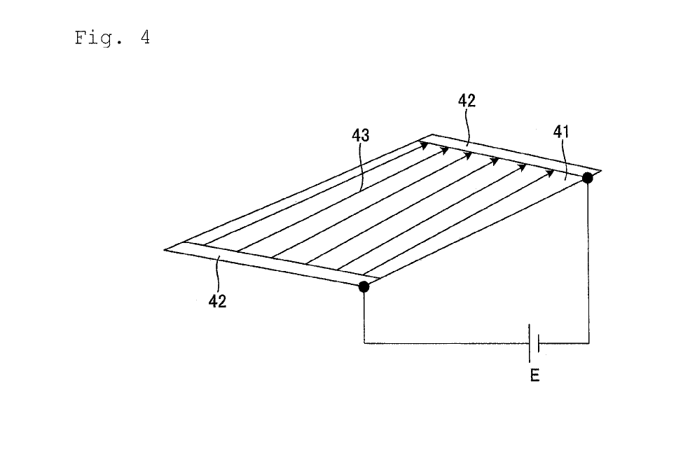

FIG. 4 is a diagram showing the principle of the plane heating film. As described above, the plane heating film comprises a piece of electrically conductive paper made by mixing carbon nanotubes with pulp fiber, and processing the resulting mixture into a sheet, sandwiching the electrically conductive paper with insulating films (i.e., laminating the electrically conductive paper), and electrodes 42 are disposed at both ends of the electrically conductive paper. As the plane heating film 41 is applied with a voltage by a power supply E, a heat generating effect is provided over the entity of the electrically conductive paper. In this event, since an infinite number of electric flux 43 is assumed to be present between the electrodes 42, the plane heating film 41 is free from the concept of wire break, as found in the conventional plane heating film.

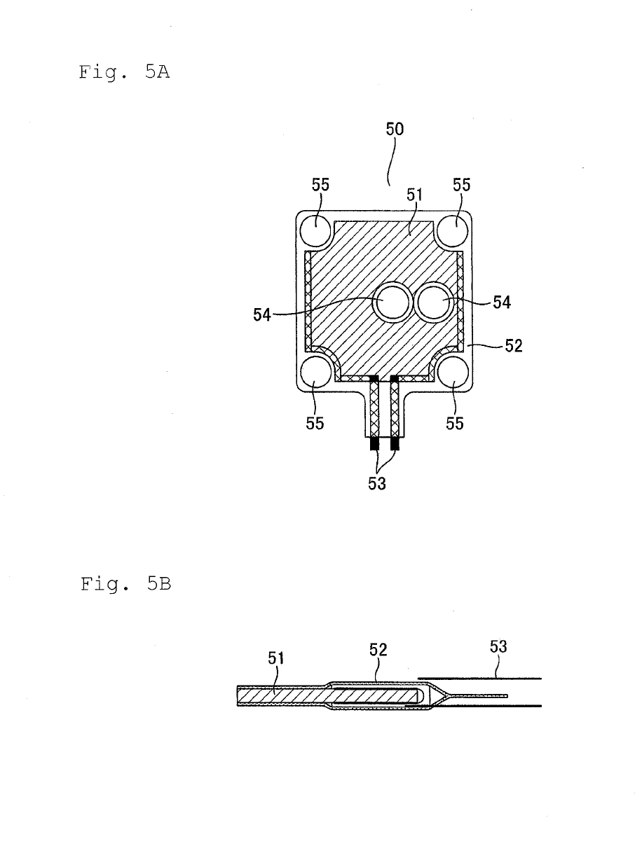

FIG. 5A is a top plan view of a plane heating film 50 according to the present invention, which comprises a piece of electrically conductive paper that contains carbon nanotubes. FIG. 5B shows a partial cross-sectional view of the plane heating film.

As described above, the plane heating film 50 comprises a piece of electrically conductive paper 51 created by mixing carbon nanotubes with pulp fiber, processing the resulting mixture into a sheet, and sandwiching the sheet with insulating films 52. Electrodes 53 are provided in an end area of the electrically conductive paper 51. The plane heating film 50 includes two gas supply ports (with gaskets) 54 for introducing and discharging a gas, and openings 55 at four corners thereof for receiving fixing screws in conformity to the shape of a mounting flange.

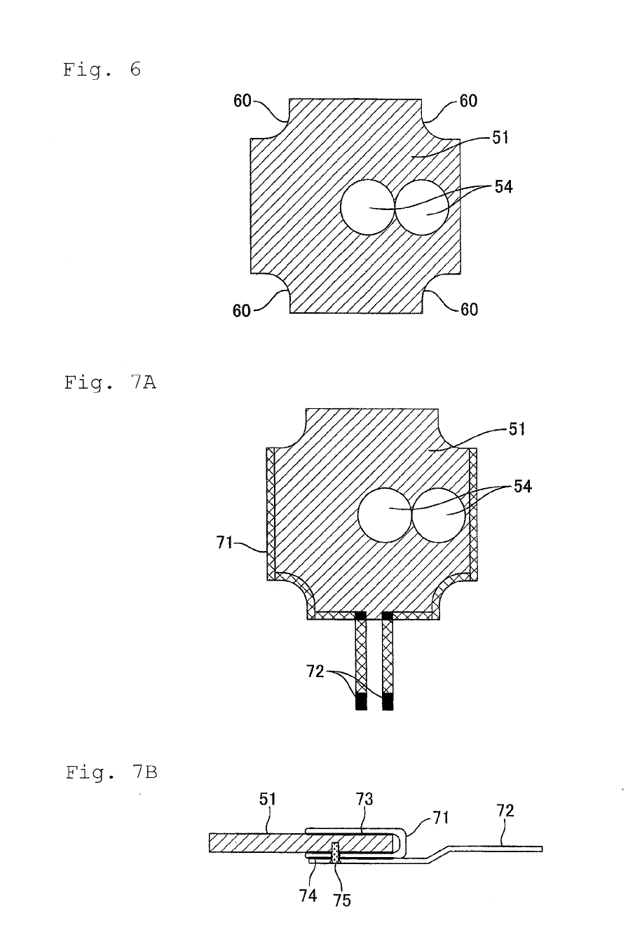

Now, a method of manufacturing the plane heating film according to the present invention will be described with reference to FIGS. 6 through 9.

First, in a first step of a plane heating film manufacturing process, a piece of raw electrically conductive paper 51, which forms part of a plane heating film, is cut in conformity to the shape of a mounting flange (not shown), gas supply ports 54, and cut-outs 60 for fixing screws, as shown in FIG. 6.

Next, in a second step, as shown in a top plan view of FIG. 7A, copper-foil electrode 71 processed in an appropriate shape for the electrode is adhered along the periphery of the electrically conductive paper 51, and then copper-foil power supply electrodes 72 for supplying power to the copper-foil electrode 71 are adhered at two end points of the electrically conductive paper 51. As shown in a partial cross-sectional view of FIG. 7B, a copper-foil electrode 71 is fitted onto the edge of the electrically conductive paper 51, and adhered thereto with an electrically conductive adhesive 73. Further, the copper-foil power supply electrodes 72 are fixed on one side of the electrically conductive paper 51 with the electrically conductive adhesive 73 and a punching 75 for fixing the electrode through high-temperature pressing, from above the copper foil 74, in such a manner that the copper foil 74 is sandwiched between the power supply electrodes 72 and the electrically conductive paper 51. The electric conductive paper 51 has a sufficiently rough surface, and the copper foil 74 is sufficiently encroached into the rough surface of the electrically conductive paper 51 through the high-temperature pressing, to produce an anchoring effect, resulting in a firm electrode structure with an extremely low contact resistance.

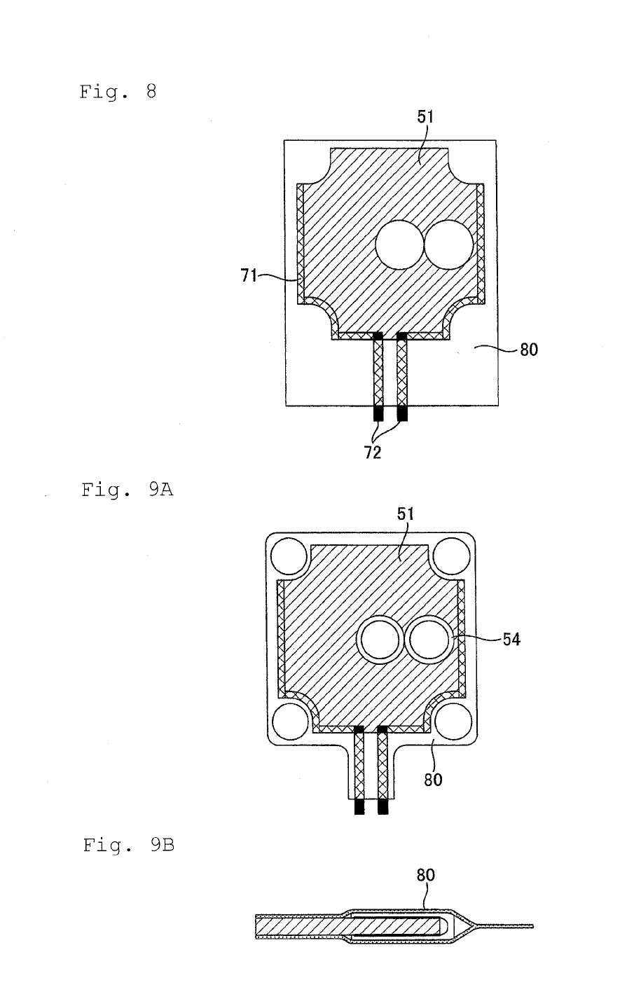

Next, in a third step, the electrically conductive paper 51 is laminated on both sides with insulating films, as shown in a top plan view of FIG. 8. Generally, a polyethylene film is used for the lamination and insulation for ensuring sufficient flexibility. However, at high temperatures of 100° C. or higher, it is not possible to use a resin which exhibits a low melting point, such as polyethylene film. Preferably, highly heat-resistive and insulating polyimide resin film is employed for the insulating film in the present invention.

Actually, a high-temperature soluble polyamide resin is coated on a polyimide film to form an insulating heat-resistive resin film 80. The electrically conductive paper 51, which has been formed with the copper-foil electrode 71 and copper-foil power supply electrodes 72, is sandwiched on both sides with the heat-resistive resin films 80. Then, the heat-resistant resin film 80 and electrically conductive paper 51 are bonded in vacuum through high-temperature, high-pressure pressing. In this way, by bonding the heat-resistive resin films 80 to the electrically conductive paper 51 in vacuum through high-temperature, high-pressure pressing to create an assembly, air remaining within the assembly is eliminated, thus enabling incombustibility to be maintained.

Finally, in a fourth step, the assembly laminated with the heat-resistive resin films 80 is punched into a desired shape with cut-out pressing or the like, as shown in a top plan view of FIG. 9A. The resulting assembly is completed as a plane heating film.

FIG. 9B shows a partial cross-sectional view of the assembly laminated with the heat-resistive resin films 80 as a completed plane heating film.

Two gas supply ports 54 for introducing and discharging a gas are preferably designed to allow metal gaskets to be mounted thereon for preventing a gas from leaking.

While the method of manufacturing a plane heating film according to the present invention has been described as a method of manufacturing a single plane heating film with reference to FIGS. 6 through 9, the present invention is preferably implemented as a mass manufacturing method in actuality.

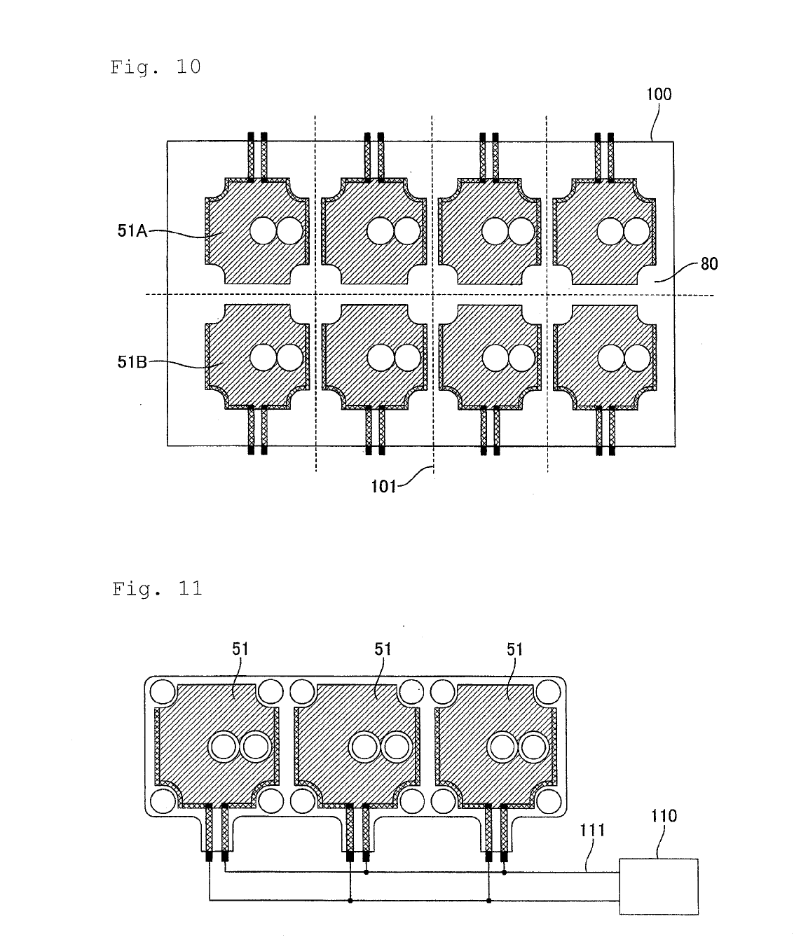

FIG. 10 shows an embodiment of a manufacturing process for mass manufacturing plane heating films according to the present invention.

A pair of electrically conductive paper 51A, 51B, each formed with the copper-foil electrode 71 and copper-foil power supply electrodes 72, as presented in the second step described above, are arranged to be opposite to each other. Then, a plurality of pairs of electrically conductive paper 51A, 51B (four pairs in FIG. 10) are placed side by side to prepare a single assembly 100. Next, the plurality of pairs of electrically conductive paper are collectively laminated on both sides with the the heat-resistive resin films 80. The heat-resistive resin films 80 and a plurality of pairs of electrically conductive paper are bonded in vacuum through high-temperature, high-pressure pressing. Subsequently, the assembly 100 is singulated along dotted lines 101 to mass manufacture several to several tens of plane heating films.

The plane heating film according to the present invention can be used alone, as a matter of course, but a plurality of the plane heating films can be connected in series in accordance with the size or thermal capacity of a particular gas flow control device which is to be heated or retained at a certain temperature.

FIG. 11 shows a specific implementation of the present invention, where three plane heating films are connected in series. Power is supplied from a power supply 110 to respective pieces of electrically conductive paper 51 through a power supply line 111.

The plane heating film of the present invention has been proven to provide significantly more energy saving effects than conventional plane heating films using metal (metal foil) resistive wires by experiments.

Specifically, a plane heating film using carbon nanotubes according to the present invention, and a conventional plane heating film using a metal (metal foil) resistive wire were created both as rectangular plane heating film having a thickness of 0.1 mm and one side of 25.5 mm. Then, power consumption per unit area, and temperature reached by generated heat were compared between the two plane heating films. The results are shown below.

Plane Heating Film Using Carbon Nanotubes According to the Present Invention:

Resistance: 65Ω;

Voltage and Current at which the temperature was reached to 80° C. by generated heat: 7.6 V, 0.1 A;

Power Consumption: 0.76 W

### Conventional Plane Heating Film Using Metal Resistive Wire:

Resistance: 21Ω;

Voltage and Current at which the temperature was reached to 80° C. by generated heat: 5.1 V, 0.2 A;

Power Consumption: 1.20 W

From the foregoing results, according to the plane heating film of the present invention, approximately 30% of energy saving effect is recognized in the amount of heat generated on planar surface per unit area.

1. A plane heating film comprising:
a piece of electrically conductive paper (51) created by mixing carbon nanotubes with pulp fiber, and processing the mixture into a sheet;
electrodes (53) disposed in an end area of said electrically conductive paper for supplying power to said electrically conductive film; and
a heat-resistive insulating film for laminating both sides of said electrically conductive paper.

2. A plane heating film according to claim 1, wherein said electrode comprises:
a copper-foil electrode (71) fitted onto the periphery and an end area of said electrically conductive paper; and
a copper-foil power supply electrode (72) for supplying power to said copper-foil electrode.

3. A plane heating film according to claim 2, wherein said copper-foil electrode and said copper-foil power supply electrode sandwich a copper foil (74) therebetween on one side of said, and said copper-foil power supply electrode is fixed with an electrically conductive adhesive and through punching (75) for fixing the electrode by high-temperature pressing from above said copper foil.

4. A plane heating film according to claim 1, wherein said heat-resistive insulating film comprises an insulating heat-resistive resin film (80) formed by coating a high-temperature soluble polyamide resin onto a polyimide film.

5. A method of manufacturing a plane heating film, comprising the steps of:
patterning a piece of electrically conductive paper (51) in conformity to the shape of the plane heating film, said electrically conductive film being created by mixing carbon nanotubes with pulp fiber, and processing the mixture into a sheet;
adhering a copper-foil electrode (71) cut into a predetermined shape and copper-foil power supply electrodes (72) for supplying power to said copper-foil electrode on the periphery and an end area of said electrically conductive paper;
laminating both sides of said patterned electrically conductive film with an insulating heat-resistive resin film (80), said insulating heat-resistive resin film being formed by coating a high-temperature soluble polyamide resin on a polyimide film; and
punching said laminated electrically conductive paper into a desired shape.

6. A plane heating film according to claim 2, wherein said heat-resistive insulating film comprises an insulating heat-resistive resin film (80) formed by coating a high-temperature soluble polyamide resin onto a polyimide film.

7. A plane heating film according to claim 3, wherein said heat-resistive insulating film comprises an insulating heat-resistive resin film (80) formed by coating a high-temperature soluble polyamide resin onto a polyimide film.
